(19) United States
(12) Patent Application Publication
(10) Pub. No.: US 2024/0411515 A1
(43) Pub. Date: Dec. 12, 2024

(54) MULTIPLIER WITH IN-PATH SUBNORMAL HANDLING

(71) Applicant: CENTREON CORPORATION, Apia (WS)

(72) Inventors: Kuo-Tseng TSENG, San Jose, CA (US); Parkson WONG, Los Altos, CA (US); Benjamin OU, San Jose, CA (US)

(73) Assignee: CENTREON CORPORATION, Apia (WS)

(21) Appl. No.: 18/207,019

(22) Filed: Jun. 7, 2023

(51) Int. Cl. G06F 7/487; G06F 7/499

(52) U.S. Cl. CPC G06F 7/4876; G06F 7/499

(57) ABSTRACT

A multiplier with in-path subnormal handling includes a zero counter, a multiplication circuit, a comparator and a rounder. The zero counter receives a first mantissa and a second mantissa, and output a zero count by adding up a first trailing-zero count, a second trailing-zero count, and at least one of a first leading-zero count and a second leading-zero count. The multiplication circuit outputs a mantissa product by multiplying the first mantissa and the second mantissa. The comparator outputs a sticky bit by comparing the zero count and a sticky portion width varying according to the most significant bit of the mantissa product. The rounder outputs a mantissa result by performing a rounding operation according to the mantissa product and the sticky bit.

### BACKGROUND

### 1. Technical Field

This disclosure relates to floating-point multiplication, and more particularly to a multiplier with in-path subnormal handling.

### 2. Related Art

A reductive OR is an OR operation performed on all bits of a binary number, where if any input bits are 1, the output bit is also 1; otherwise, it is 0. However, the method of directly using multiple OR gates to implement a reductive OR operation is not only slow but also increases the hardware cost.

In the process of multiplying two floating-point numbers, there are two steps in which the reductive OR operation can be applied. One step is to confirm whether an input is normal or subnormal. A subnormal floating-point number has an exponent field of all zero and a mantissa field of non-zero. Therefore, performing a reductive OR operation on the exponential field helps determine whether the input is subnormal. Another step is to determine the sticky bit of the multiplication result for rounding. Specifically, the multiplication result is formed by a mantissa of multiple bits, a guard bit, a round bit, and the remaining bits for determining the sticky bit. The sticky bit is determined by performing the reductive OR operation on these remaining bits.

When the two inputs of the multiplication are normal numbers, a trailing zero approach may be performed in parallel to the multiplication so as to save time over the reduction OR operation. Specifically, this approach includes: counting the quantity of trailing zeros of the two inputs separately, adding up the two trailing zero counts to obtain a sum, and comparing the sum to the sticky portion (the number of bits for the sticky bit determination). If the sum is greater than or equal to the sticky portion, the sticky bit is 0; otherwise, the sticky bit is 1. However, this approach fails when subnormal inputs are involved.

### SUMMARY

In view of the above, the present disclosure proposes a multiplier with in-path subnormal handling to eliminate subnormal identification latency and enhance the trailing zero method for determining the sticky bit.

According to an embodiment of the present disclosure, a multiplier with in-path subnormal handling includes a zero counter, a multiplication circuit, a comparator, and a rounder. The zero counter receives a first mantissa and a second mantissa, and outputs a zero count by adding up a first trailing-zero count, a second trailing-zero count, and at least one of a first leading-zero count and a second leading-zero count. The multiplication circuit receives the first mantissa and the second mantissa, and outputs a mantissa product by multiplying the first mantissa and the second mantissa. The comparator is coupled to the zero counter and the multiplication circuit for receiving the zero count and a most significant bit of the mantissa product. The comparator outputs a sticky bit by comparing the zero count and a sticky-bit width varying according to the most significant bit of the mantissa product. The rounder is coupled to the multiplication circuit and the comparator for receiving the mantissa product and the sticky bit. The rounder outputs a mantissa result by performing a rounding operation according to the mantissa product and the sticky bit.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a block diagram of the multiplier with in-path subnormal handling according to an embodiment of the present disclosure;

FIG. 2 is a block diagram of a first embodiment of the zero counter;

FIG. 3 is a block diagram of a second embodiment of the zero counter;

FIG. 4 is a block diagram of a third embodiment of the zero counter;

FIG. 5 is a block diagram of a first embodiment of the multiplication circuit;

FIG. 6 is a block diagram of a second embodiment of the multiplication circuit;

FIG. 7 is a block diagram of a third embodiment of the multiplication circuit;

FIG. 8 is a block diagram of a first embodiment of the customized multiplier and the three-input adder;

FIG. 9 is a block diagram of a second embodiment of the customized multiplier and the three-input adder; and

FIG. 10 is a block diagram of a third embodiment of the customized multiplier and the three-input adder.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The present disclosure proposes a multiplier with in-path subnormal handling, which receives and multiplies a first operand and a second operand to output a product. In an embodiment, the first operand and the second operand conform to the IEEE Standard for Floating-Point Arithmetic (IEEE 754). Namely, the first operand includes a first sign, a first exponent and a first mantissa, and the second operand includes a second sign, second exponent and a second mantissa. The present disclosure focuses on the operation upon the exponents and mantissas, since the sign bits may be processed independently in floating-point multiplication.

Given the first operand denoted as A and the second operand denoted as B, there are four input cases: (1) Neither A nor B is subnormal; (2) Only A is subnormal; (3) Only B is subnormal; and (4) Both A and B are subnormal. The present disclosure focuses on cases (1), (2) and (3). The case (4) leads to an underflow condition, and the product A×B should be hardwired to zero since it is too small to be represented in IEEE 754 format.

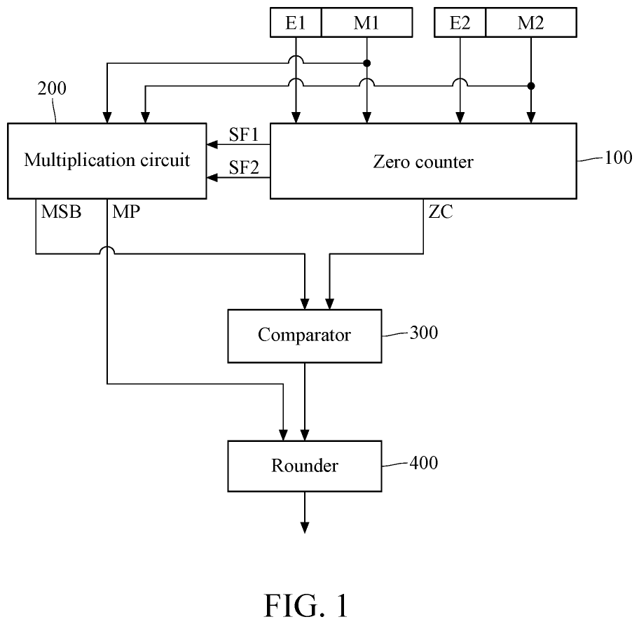

FIG. 1 is a block diagram of the multiplier with in-path subnormal handling according to an embodiment of the present disclosure. As shown in FIG. 1, the multiplier with in-path subnormal handling includes a zero counter 100, a multiplication circuit 200, a comparator 300, and a rounder 400.

The zero counter 100 receives the first exponent E1, the first mantissa M1, the second exponent E2 and the second mantissa M2. The zero counter 100 outputs a zero count ZC according to the first mantissa M1 and the second mantissa M2. The zero count ZC is composed of a leading zero count of the first mantissa M1, a trailing zero count of the first mantissa M1, a leading zero count of the second mantissa M2, and a trailing zero count of the second mantissa M2. For example, if the first mantissa M1 is “0001110” and the second mantissa M2 is “1100100”, the first mantissa M1 has 3 leading zeros and 1 training zero, the second mantissa M2 has 0 leading zero and 2 trailing zeros, and the zero count ZC would be 6 (3+1+0+2).

The multiplication circuit 200 receives the first mantissa M1 and the second mantissa M2, and outputs a mantissa product MP by multiplying the first mantissa M1 and the second mantissa M2. The mantissa product MP includes a plurality of bits, where the most significant bit (MSB) is denoted as MSB in FIG. 1.

The comparator 300 is coupled to the zero counter 100 and the multiplication circuit 200 for receiving the zero count ZC and MSB.

The comparator 300 determines a sticky portion width according to the MSB. Taking single precision as an example, multiplying two 24-bit mantissas generates a 48-bit result. Except for a normalized mantissa of 24 bits and a round bit of 1 bit, the remaining bits (hereinafter referred to sticky portion) are used for the sticky bit determination. The normalized mantissa must always begin with 1, but the MSB of the result may be 0 or 1. Therefore, the sticky-bit width may be 23 or 22 depending on the MSB. Specifically, in the carry-out case (MSB is 1), the sticky portion include the lowest 23 bits (48-24-1); in the no-carry case (MSB is 0), the sticky portion include the lowest 22 bits (48-1-24-1). Overall, the sticky portion in the carry-out case is exactly 1 bit wider than that in the no-carry case.

The comparator 300 determines a sticky bit by comparing the zero count ZC and the sticky portion width. The sticky bit is 1 if the zero count ZC is less than the sticky portion width. The sticky bit is 0 if the zero count ZC is greater than or equal to the sticky portion width.

The rounder 400 is coupled to the multiplication circuit 200 and the comparator 300 for receiving the mantissa product MP and the sticky bit. The rounder 400 outputs a rounding mantissa by performing a rounding operation according to the mantissa product MP and the sticky bit. The rounder 400 is a standard component incorporated in the multiplier for completeness. Therefore, the present disclosure does not limit the implementation method of the rounder 400.

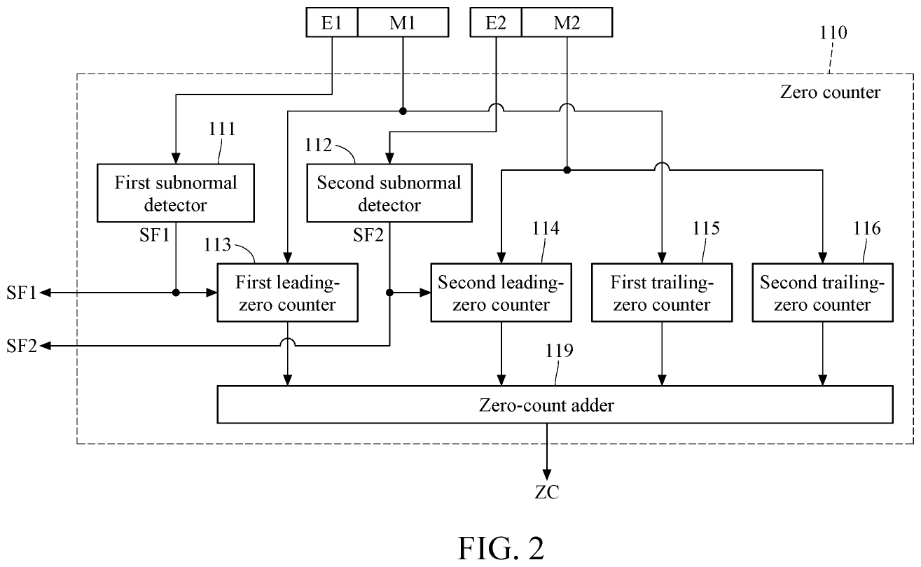

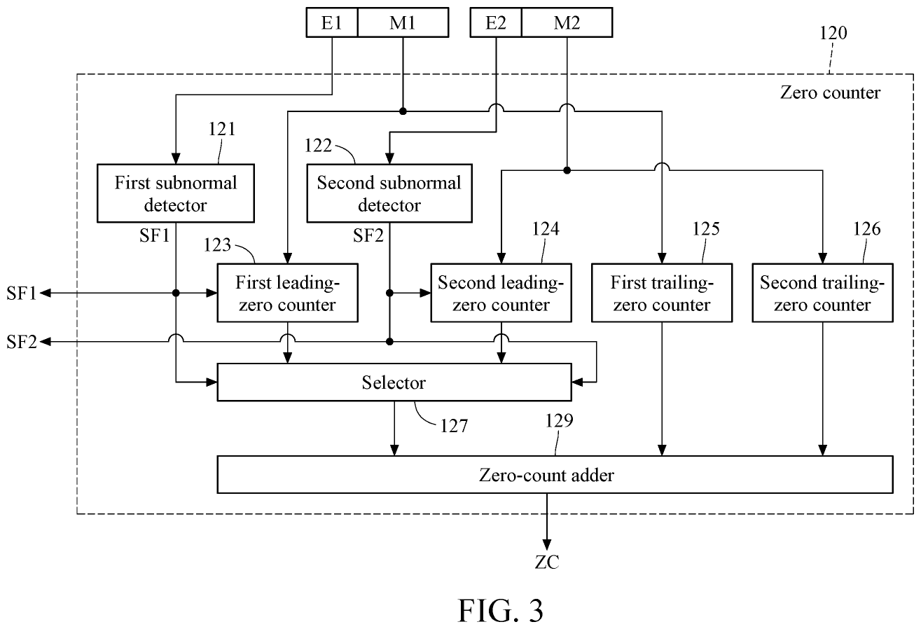

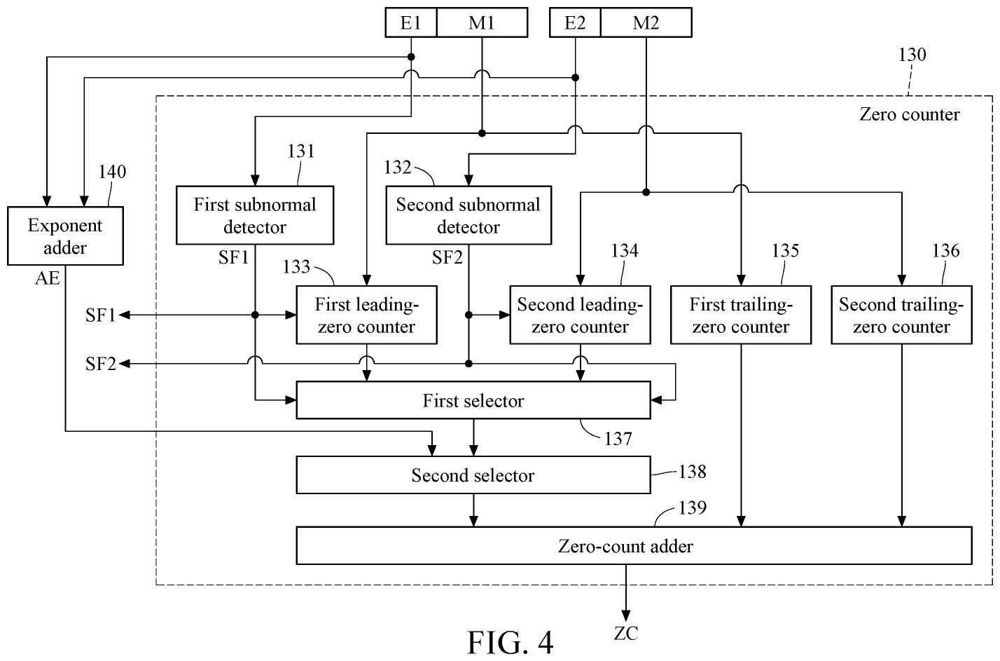

FIG. 2, FIG. 3, and FIG. 4 depict three embodiments of the zero counter 100 respectively.

FIG. 2 is a block diagram of a first embodiment of the zero counter. As shown in FIG. 2, the zero counter 110 of the first embodiment includes a first subnormal detector 111, a second subnormal detector 112, a first leading-zero counter 113, a second leading-zero counter 114, a first trailing-zero counter 115, a second trailing-zero counter 116, and a zero-count adder 119.

The first subnormal detector 111 receives the first exponent E1 and outputs a first subnormal flag SF1 by determining whether the first exponent E1 is zero. In an example, the first subnormal flag SF1 is true if the first exponent E1 is zero, and the first subnormal flag SF1 is false if the first exponent E1 is not zero.

The second subnormal detector 112 receives the second exponent E2 and outputs a second subnormal flag SF2 by determining whether the second exponent E2 is zero. In an example, the second subnormal flag SF2 is true if the second exponent E2 is zero, and the second subnormal flag SF2 is false if the second exponent E2 is not zero.

The first subnormal flag SF1 and the second subnormal flag SF2 are one-bit signal that indicate whether the first mantissa M1 or the second mantissa M2 come from subnormal operands.

The first leading-zero counter 113 is coupled to the first subnormal detector 111 for receiving the first subnormal flag SF1, and receives the first mantissa M1. If the first subnormal flag SF1 is true, meaning that the first operand is subnormal, the first leading-zero counter 113 outputs a first leading-zero count representing the quantity of leading zero(s) of the first mantissa M1. If the first subnormal flag SF1 is false, meaning that the first operand is normal, the first leading-zero counter 113 outputs “0” as the first leading-zero count.

The second leading-zero counter 114 is coupled to the second subnormal detector 112 for receiving the second subnormal flag SF2, and receives the second mantissa M2. If the second subnormal flag SF2 is true, meaning that the second operand is subnormal, the second leading-zero counter 114 outputs a second leading-zero count representing the quantity of leading zero(s) of the second mantissa M2. If the second subnormal flag is false, meaning that the second operand is normal, the second leading-zero counter 114 outputs “0” as the second leading-zero count.

Overall, the leading-zero counter does not need to compute the quantity of leading zero(s) when the operand is a normal number, since the mantissa of a normal floating number has an implicit leading 1 to the left of all mantissa bits.

The first trailing-zero counter 115 receives the first mantissa M1 and outputs a first trailing-zero count representing the quantity of trailing-zero(s) of the first mantissa M1.

The second trailing-zero counter 116 receives the second mantissa M2 and outputs a second trailing-zero count representing the quantity of trailing-zero(s) of the second mantissa M2.

The zero-count adder 119 is coupled to the first leading-zero counter 113, the second leading-zero counter 114, the first trailing-zero counter 115, and the second trailing-zero counter 116 for receiving the first leading-zero count, the second leading-zero count, the first trailing-zero count, and the second trailing-zero count. The zero-count adder 119 outputs a zero count ZC by adding up the first leading-zero count, the second leading-zero count, the first trailing-zero count, and the second trailing-zero count.

FIG. 3 is a block diagram of a second embodiment of the zero counter. As shown in FIG. 3, the second embodiment of the zero counter 120 includes a first subnormal detector 121, a second subnormal detector 122, a first leading-zero counter 123, a second leading-zero counter 124, a first trailing-zero counter 125, a second trailing-zero counter 126, a selector 127, and a zero-count adder 129.

In the second embodiment of the zero counter 120, the two subnormal detectors 121, 122 and the four zero counters 123-126 are identical to that of the first embodiment of the zero counter 110, and their details are not repeated here.

The selector 127 is coupled to the first subnormal detector 121, the second subnormal detector 122, the first leading-zero counter 123 and the second leading-zero counter 124 for receiving the first subnormal flag SF1, the second subnormal flag SF2, the first leading-zero count and the second leading-zero count. The selector 127 outputs a selection result by selecting one of the first leading-zero count, the second leading-zero count, and zero according to the first subnormal flag SF1 and the second subnormal flag SF2. Specifically, the selector 127 outputs the first leading-zero count when the first subnormal flag is true and the second subnormal flag is false. The selector 127 outputs the second leading-zero count when the first subnormal flag is false and the second subnormal is true. The selector 127 outputs “0” when the first subnormal flag and the second normal flag are both true or both false.

Referring to the aforementioned paragraph, if both the first leading-zero count and the second leading-zero count are non-zero, the proposed multiplier may directly output zero without further computation due to underflow condition. Therefore, compared to the first embodiment, the second embodiment of the zero counter 120 uses the selector 127 to select the non-zero one of the first leading-zero count and the second leading-zero count, and the number of inputs of the zero-count adder 129 may be reduced from four to three.

The zero-count adder 129 is coupled to the selector 127, the first trailing-zero counter 125 and the second trailing-zero counter 126 for receiving the selection result, the first trailing-zero count and the second trailing-zero count. The zero-count adder 129 adds up the first trailing-zero count, the second trailing-zero count, and the non-zero one of the first leading-zero count and the second leading-zero count to output the zero count ZC.

FIG. 4 is a block diagram of a third embodiment of the zero counter. Compared to the second embodiment, the third embodiment of the zero counter 130 is further coupled to an exponent adder 140 for receiving an adjusted exponent AE. As shown in FIG. 4, the zero counter 130 includes a first subnormal detector 131, a second subnormal detector 132, a first leading-zero counter 133, a second leading-zero counter 134, a first trailing-zero counter 135, a second trailing-zero counter 136, a first selector 137, a second selector 138, and the zero-count adder 139.

In the third embodiment of the zero counter 130, the two subnormal detectors 131, 132 and the four zero counters 133-136 may refer to the first or second embodiment, and their details are not repeated here. In addition, the third embodiment of the first selector 137 is equivalent to the second embodiment of the selector 127, and the output of the first selector 137 is called a first selection result in the third embodiment.

The exponent adder 140 receives the first exponent E1 and the second exponent E2. The exponent adder 140 outputs the adjusted exponent AE by adding up the first exponent E1, the second exponent E2 and a threshold. The threshold is the minimum representable exponent in the adopted precision. For example, the threshold is −126 in the single precision or −1022 in the double precision. The threshold may be stored in the exponent adder 140 or be inputted from an external component. In addition, the exponent adder 140 may be used to output a result exponent, which is an essential output of a floating-point multiplier and is estimated by adding up the first exponent E1, the second exponent E2 and an exponent bias.

The second selector 138 is coupled to the first selector 137 and the exponent adder 140 for receiving the first selection result (i.e., the leading zero count of the subnormal operand) and the adjusted exponent AE. The second selector 138 outputs a second selection result by selecting a smaller one of the adjusted exponent AE and the first selection result.

The zero-count adder 139 is coupled to the second selector 138, the first trailing-zero counter 135, and the second trailing-zero counter 136 for receiving the second selection result, the first trailing-zero count, and the second trailing-zero count. The zero-count adder 139 adds up the first trailing-zero count, the second trailing-zero count, and the smaller one of the adjusted exponent AE and the leading-zero count as the zero count ZC.

As a review, please refer to FIG. 1 and FIG. 2. The operation of the comparator 300 with the first embodiment of the zero counter 110 can be summarized as the following judgement:

if(TZ1+TZ2+LZ1+LZ2)≥W, then S=1; otherwise, S=0;
where TZ1 denotes the first trailing-zero count, TZ2 denotes the second trailing-zero count, LZ1 denotes the first leading-zero count, LZ2 denotes the second leading-zero count, W denotes the sticky portion width, and S denotes the sticky bit, namely the output of the comparator 300.

Please refer to FIG. 1 and FIG. 3. Since LZ1 and LZ2 will not both be 0, the operation of the comparator 300 with the second embodiment of the zero counter 120 can be summarized as the following judgement:

if(TZ1+TZ2+LZ)≥W, then S=1; otherwise, S=0;
where LZ denotes the non-zero one of the first leading-zero count and the second leading-zero count.

Please refer to FIG. 1 and FIG. 4. The operation of the comparator 300 with the third embodiment of the zero counter 130 can be summarized as the following judgement:

if [TZ1+TZ2+min(LZ,Δ)]≥W, then S=0;otherwise, S=1;
where Δ denotes adjusted exponent AE, and min ( ) is the minimum function returning the lower of its two operands. A is defined as the following formula:

$$Δ = E 1 + E 2 - E 3 ;$$

where E1 denotes the first exponent, E2 denotes the second exponent, and E3 denotes the threshold (minimum representable exponent in the adopted precision).

Certain exponent cases may introduce the normalization and thus affect the zero count ZC. Specifically, if the result exponent is below the minimum representable exponent (−126 in single precision, for example), the result mantissa must actually be right-shifted to bring the exponent back up to −126. There is also the case where, when left-shifting out leading zeros, shifting out all the zeros would bring the exponent below the minimum representable exponent. Both of these cases must be taken into account.

To see how the third embodiment of the zero counter 130 handles the right-shifting case, notice that right-shifting occurs when Δ is less than 0. Since LZ is strictly non-negative, this means in the right-shifting case min (LZ,Δ)=Δ and is strictly negative. In this case, the magnitude of Δ represents the amount of right-shifting needed to bring the result exponent back up to the minimum exponent value, and it is negative because each bit of right-shifting shifts out a trailing zero from the sticky portion, reducing the total number of trailing zeros in the sticky portion.

To see how the third embodiment of the zero counter 130 handles the left-shifting-below-the-minimum-exponent case, note that in this case Δ is positive, and represents the shift distance needed to reach the minimum exponent. This demonstrates the utility of using the min ( ) function: when LZ, the leading zero count, is smaller than Δ, then the operation of left-shifting out of leading zeros will not cause the result exponent below the minimum exponent. Thus, LZ can straightforwardly be taken as the result of min (LZ,Δ).

In the case where Δ is smaller than LZ, shifting the full distance of LZ would bring the result exponent below the minimum exponent, which is unacceptable. Thus, instead of shifting by LZ bits, we simply shift by Δ bits, which is exactly enough to not exceed the minimum exponent, which is straightforwardly reflected in the result of min (LZ,Δ) being A in this case.

In sum, the above description shows how to calculate the sticky bit, using some combination of trailing zero counts TZ1 and TZ2, leading zero counts LZ, and adjusted exponent AE.

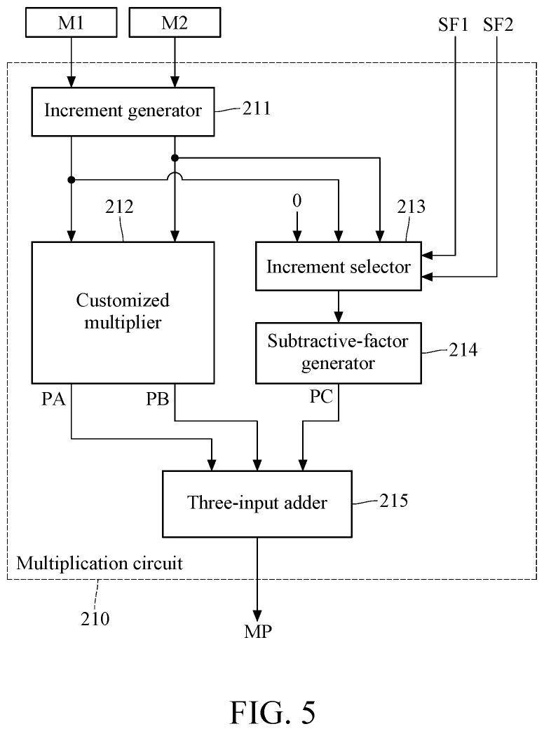

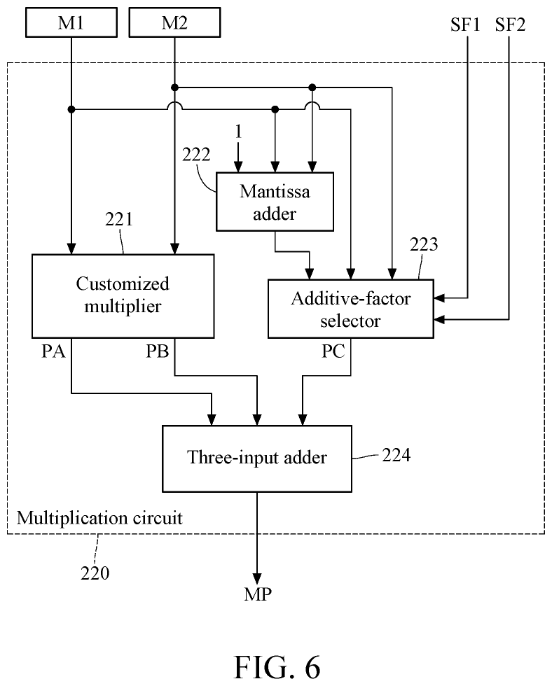

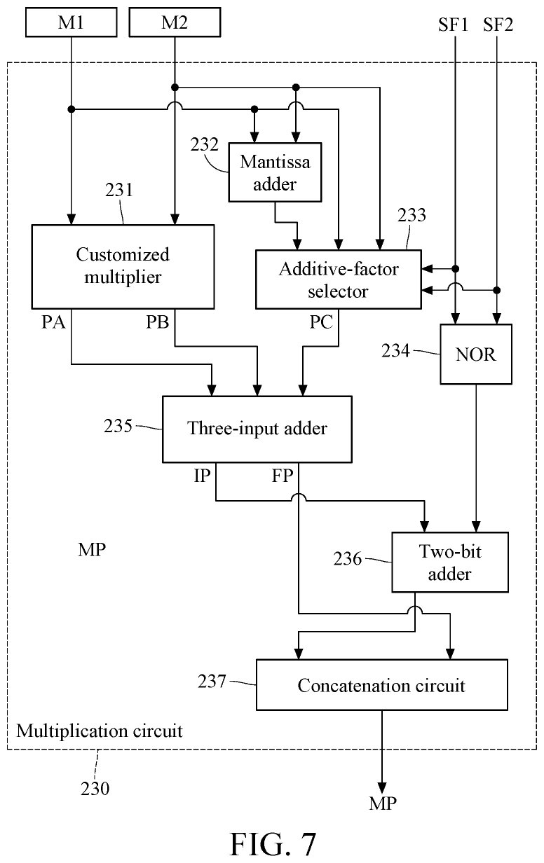

Please refer to FIG. 1. The multiplication circuit 200 is coupled to the zero counter 100 for receiving the first subnormal flag SF1 and the second subnormal flag SF2. FIG. 5, FIG. 6, and FIG. 7 depict three embodiments of the multiplication circuit 200 respectively.

FIG. 5 is a block diagram of a first embodiment of the multiplication circuit. As shown in FIG. 5, the multiplication circuit 210 includes an increment generator 211, a customized multiplier 212, an increment selector 213, a subtractive-factor generator 214, and a three-input adder 215.

The increment generator 211 receives the first mantissa M1 and the second mantissa M2. The increment generator 211 outputs a first mantissa increment by adding 1 to the first mantissa M1, and output a second mantissa increment by adding 1 to the second mantissa M2. In other words, if the first mantissa M1 is X and the second mantissa M2 is Y, the increment generator 211 outputs 1+X and 1+Y, respectively.

The customized multiplier 212 is coupled to the increment generator 211 for receiving the first mantissa increment and the second mantissa increment. The customized multiplier 212 multiplies the first mantissa increment and the second mantissa increment to outputs two partial products PA, PB, where the sum of the two partial products PA, PB is equal to a product of the first mantissa increment and the second mantissa increment, i.e., PA+PB=(1+X)×(1+Y). In an example, as long as the multiplier apparatus that ends in adding a final two partial products (here denoted PA and PB) into a final product, any existing multiplier structure such as traditional adder tree or Wallace tree may be modified to implement the customized multiplier 212. Other implementations of the customized multiplier 212 will be described later.

The increment selector 213 is coupled to the increment generator 211 for receiving the first mantissa increment and the second mantissa increment, and receives the first subnormal flag SF1 and the second subnormal flag SF2 outputted from the zero counter 100. Specifically, the increment selector 213 outputs one of the first mantissa increment, the second mantissa increment, and zero according to the first subnormal flag SF1 and the second subnormal flag SF2, and the selection method may follow Table 1 below. In other words, the selection result is one of 1+X, 1+Y, and 0.

TABLE 1

| First | Second | |
|---|---|---|
| subnormal flag | subnormal flag | Selection result |
| True | True | Don't care |
| True | False | Second mantissa increment |
| False | True | First mantissa increment |
| False | False | 0 |

The subtractive-factor generator 214 is coupled to the increment selector 213 for receiving the selection result. The subtractive-factor generator outputs a subtractive factor PC, which is the two's complement of the selection result, i.e., PC=−(1+X),−(1+Y), or 0.

The three-input adder 215 is coupled to the customized multiplier 212 and the subtractive-factor generator 214 for receiving the two partial products PA, PB and the subtractive factor PC. The three-input adder 215 output a mantissa product MP by adding up the two partial products PA and the subtractive factor PC, i.e., MP=PA+PB+PC.

Here is the mathematical concept corresponding to the first embodiment of FIG. 5. In IEEE 754, a mantissa field of a normal number is interpreted to have an implicit one to the left of the leftmost bit. For example, a mantissa field of “001” is interpreted to have the value “1.001”. Supposed that the first mantissa M1 is X and the second mantissa M2 is Y, when the first operand and the second operand are both normal, the multiplication of the two mantissas is shown as Equation 1 below:

$$( 1 + X ) \times ( 1 + Y ) = 1 + X + Y + X Y . \qquad ( Equation 1 )$$

The “1+” in each factor represents the implicit one of each operand since the implicit one is always in the ones place.

On the other hand, a mantissa field of a subnormal number is interpreted to have an implicit zero to the left of the leftmost bit. For example, a mantissa field of “001” is interpreted to have the value “0.001”. When the first operand is subnormal, the multiplication of the two mantissas is shown as Equation 2 below:

$$( 0 + X ) \times ( 1 + Y ) = X + X Y . \qquad ( Equation 2 )$$

When the second operand is subnormal, the multiplication of the two mantissas is shown as Equation 3 below:

$$( 1 + X ) \times ( 0 + Y ) = Y + X Y . \qquad ( Equation 3 )$$

Equation 1 differs from the Equation 2 by a subtractive factor 1+Y, and differs from the Equation 3 by another subtractive factor 1+X. Therefore, instead of waiting for the reductive OR signals (SF1, SF2), the customized multiplier in FIG. 5 simply proceeds with the multiplication as if the inputs were normal, producing the output 1+X+Y+XY. By the time the multiplication is done, it is also determined which operand is subnormal, and this can be used to determine whether to subtract anything, and if so, whether to subtract 1+X or 1+Y. This approach may hide the latency associated with the reductive OR needed to identify a subnormal input. This is because while the additional latency of subtracting the subtractive factor may seem greater than the latency saved by parallelizing the reductive OR, the use of the three-input adder 215 and customized multiplier 212 almost completely eliminates that latency by exploiting the fact that a standard three-input adder has minimal added latency over a two-input adder. Thus, by effectively replacing one of the two-input adders of a standard multiplier's adder tree with a three-input adder, one extra subtractive factor can be incorporated into the computation without significant latency cost.

FIG. 6 is a block diagram of a second embodiment of the multiplication circuit. As shown in FIG. 6, the multiplication circuit 220 includes a customized multiplier 221, a mantissa adder 222, an additive-factor selector 223, and a three-input adder 224.

The customized multiplier 221 receives and multiplies the first mantissa M1 and the second mantissa M2 to output two partial products, PA and PB. The second embodiment of the customized multiplier 221 is basically identical to the customized multiplier 212 of the first embodiment, except their inputs.

The mantissa adder 222 receives the first mantissa M1 and the second mantissa M2 and outputs a sum increment by adding up the first mantissa M1, the second mantissa M2 and 1. For example, if the first mantissa M1 is X and the second mantissa M2 is Y, the sum increment is 1+X+Y.

The additive-factor selector 223 is coupled to the mantissa adder 222 for receiving the sum increment, and receives the first mantissa M1 and the second mantissa M2, and receives the first subnormal flag SF1 and the second subnormal flag SF2 outputted from the zero counter 100. Specifically, the additive-factor selector 223 outputs an additive factor by selecting one of the sum increment, the first mantissa M1, and the second mantissa M2 according to the first subnormal flag SF1 and the second subnormal flag SF2, and the selection may follow Table 2 below. In other words, the additive factor PC=1+X+Y, X, or Y.

TABLE 2

| First subnormal flag | Second subnormal flag | Additive factor |
|---|---|---|
| True | True | Don't care |
| True | False | First mantissa |
| False | True | Second mantissa |
| False | False | Sum increment |

The three-input adder 224 is coupled to the customized multiplier 221 and the additive-factor selector 223 for receiving the two partial products PA, PB and the additive factor PC. The three-input adder 224 outputs a mantissa product MP by adding up the two partial products PA, PB and the additive factor PC, i.e., MP=PA+PB+PC.

Here is the mathematical concept corresponding to the second embodiment of FIG. 6. Instead of computing 1+X+Y+XY and then subtracting either 1+X or 1+Y, the multiplication circuit 220 multiplies X and Y to generate XY, and then adds either X, Y, or 1+X+Y.

FIG. 7 is a block diagram of a third embodiment of the multiplication circuit. As shown in FIG. 7, the multiplication circuit 230 includes a customized multiplier 231, a mantissa adder 232, an additive-factor selector 233, a NOR logic circuit 234, a three-input adder 235, a two-bit adder 236, and a concatenation circuit 237.

The third embodiment of the customized multiplier 231 is identical to the second embodiment of the customized multiplier 221, and its details is not repeated here.

The mantissa adder 232 receives and adds the first mantissa M1 and the second mantissa M2 to output a mantissa sum. For example, if the first mantissa M1 is X and the second mantissa M2 is Y, the mantissa sum is X+Y.

The additive-factor selector 233 is coupled to the mantissa adder 232 for receiving the mantissa sum and receives the first subnormal flag SF1 and the second subnormal flag SF2 outputted from the zero counter 100. Specifically, the additive-factor selector 233 outputs an additive factor by selecting one of the mantissa sum, the first mantissa E1, and the second mantissa E2 according to the first subnormal flag SF1 and the second subnormal flag SF2 and the selection may follow Table 2 above. In other words, in the third embodiment, the additive factor PC=X+Y, X, or Y.

The NOR logic circuit 234 receives the first subnormal flag SF1 and the second subnormal flag SF2, and outputs a NOR result by performing a NOR operation on them.

The third embodiment of the three-input adder 235 is identical to the second embodiment of the three-input adder 224. It should be noted that the output of the three-input adder 235 is a temporary sum. The temporary sum includes an integer portion IP and a fractional portion FP. The integer portion IP is the uppermost two bits of the temporary sum and the fractional portion FP is the remaining bits of the temporary sum.

The two-bit adder 236 is coupled to the NOR logic circuit 234 and the three-input adder 235 for receiving the NOR result and the integer portion IP. The two-bit adder 236 outputs a two-bit result by adding up the NOR result and the integer portion IP.

The concatenation circuit 237 is coupled to the three-input adder 235 and the two-bit adder 236 for receiving the fractional portion FP and the two-bit result. The concatenation circuit 237 outputs the mantissa product MP whose uppermost two bits are the two-bit result and the remaining bits are the fractional portion FP.

Overall, the third embodiment of the multiplication circuit 230 additionally handles the integer portion of the mantissa product MP. If the first mantissa M1 is X and the second mantissa M2 is Y, X and Y are on the interval [0,1), so XY is on the interval [0,1), which means XY has no integer bits. Further, 1+X+Y+XY is on the interval [0,4), so it has up to 2 integer bits. When the NOR logic circuit 234 detects that the first subnormal flag SF1 and the second subnormal flag SF2 are both false, it means that the first operand and the second operand are both normal. In this case, the mantissa product MP should be computed as 1+X+Y+XY, where X+Y can be selected by the additive-factor selector 233, X+Y+XY can be outputted by the three-input adder 235, and an additional 1 can be added to the one's place of the temporary sum by the two-bit adder 236. Once this addition is done, the upper two bits can simply be prepended to the fractional portion FP outputted by the three-input adder 235 to generate the mantissa product MP.

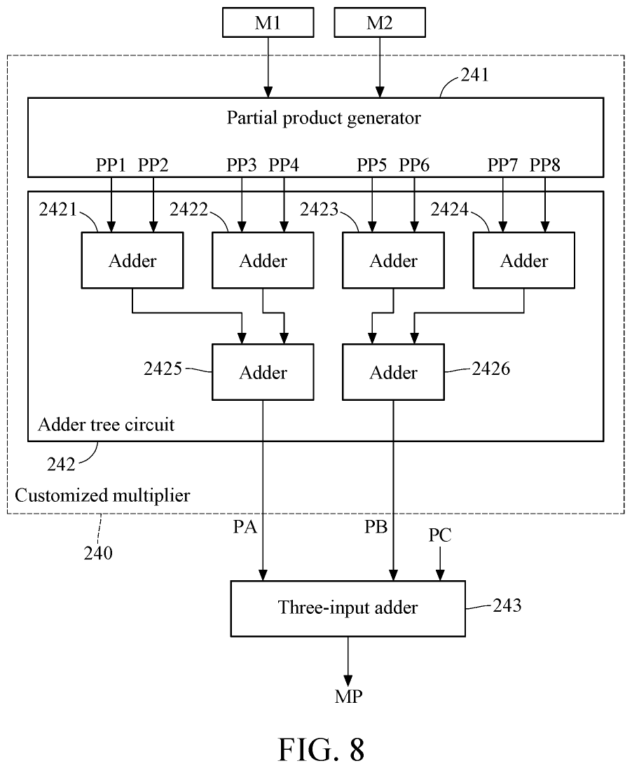

In the embodiments shown in FIG. 5 to FIG. 7, the customized multiplier 212/221/231 has two outputs (partial products), PA and PB, and the sum of these two outputs relates to the product of the first mantissa E1 and the second mantissa E2. These two outputs may be extracted by removing the adder used for the final addition in existing hardware multipliers. Please refer to FIG. 8 for the detail.

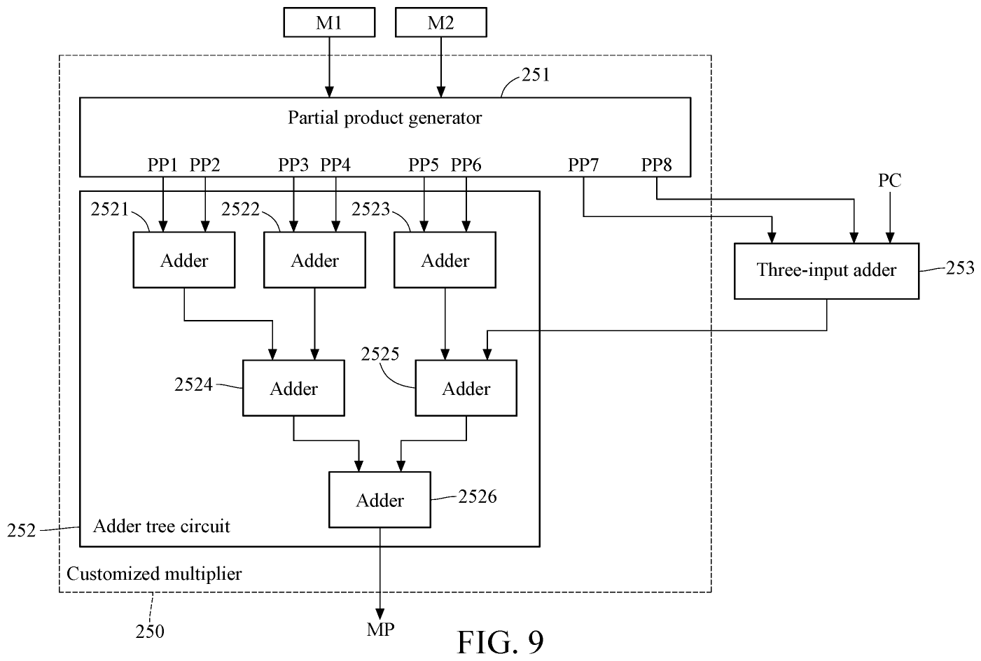

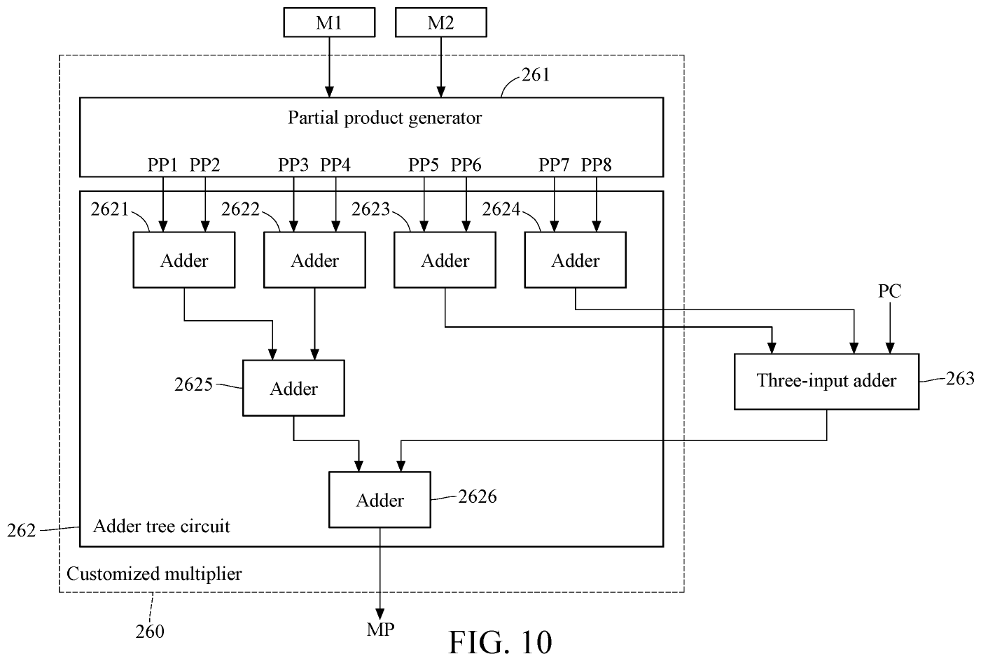

FIG. 8, FIG. 9, and FIG. 10 depict three embodiments of the customized multiplier and the three-input adder.

FIG. 8 is a block diagram of a first embodiment of the customized multiplier and the three-input adder. As shown in FIG. 8, the customized multiplier 240 includes a partial product generator 241 and an adder tree circuit 242.

The partial product generator 241 receives the first mantissa M1 and the second mantissa M2 to generate a plurality of partial products, denoted as PP1 to PP8. The present disclosure does not limit the number of partial products or the bit width of each partial product. In the example shown in FIG. 8, both the first mantissa E1 and the second mantissa E1 are 8 bits, the partial product generator 241 multiplies each corresponding bit to output PP1 to PP8.

The adder tree circuit 242 is coupled to the partial product generator 241 for receiving the partial products PP1 to PP8. The adder tree circuit 242 includes a plurality of adder 2421 to 2426 arranged in a tree structure, and finally outputs two partial products PA, PB. Each adder is a two-input adder. However, the present disclosure does not limit the number of adders or the tree structure. In an example, any existing multiplier structure such as traditional adder tree or Wallace tree may be modified to implement the adder tree circuit 242.

The three-output adder 243 is coupled to the adder tree circuit 242 for receiving the two partial product PA, PB, and receives a selection output PC, which may be a subtractive factor of the embodiment shown in FIG. 5 or an additive factor of the embodiments shown in FIG. 6 and FIG. 7.

Regarding the location of the three-input adder, in the embodiment presented above, the three-input adder 215/224/235/243 is shown to take the place of the terminating adder in the multiplier's reduction tree. However, this is not the only possible location. Most multipliers include a plurality of reduction layers in a tree of adders, and in principle any two-input adder in that tree can be replaced with a three-input adder that “sneaks in” the selected result.

In the embodiment shown in FIG. 8, the three-input adder 243 and the adder tree circuit 242 form a reduction tree structure of common multiplier, where the three-input adder 243 is located at the terminating position. However, the present disclosure does not limit the location of the three-input adder 243. In fact, any two-input adder in the adder tree circuit 242 may be replaced by a three-input adder that additionally adds the selection result. Please refer to FIG. 9 and FIG. 10 for the detail.

FIG. 9 is a block diagram of a second embodiment of the customized multiplier 250 and the three-input adder 253, wherein the implementations of the partial product generator 251 and the adder tree circuit 252 may refer to the partial product generator 241 and the adder tree circuit 242 shown in FIG. 8. The three-input adder 253 is coupled to the partial product generator 251 for receiving two partial products PP7, PP8. As mentioned before, the third input of the three-input adder 253 may come from subtractive-factor generator 233 of FIG. 5 or additive-factor generator 223 or 233 of FIG. 6 or 7. The output of the three-input adder 253 is coupled to the adder 2525 of the plurality of adders 2521-2526 of the adder tree circuit 252.

FIG. 10 is a block diagram of a third embodiment of the customized multiplier 260 and the three-input adder 263, wherein the implementations of the partial product generator 261 and the adder tree circuit 262 may refer to the partial product generator 241 and the adder tree circuit 242 shown in FIG. 8. The three-input adder 263 is coupled to the adder tree structure 262 for receiving two outputs of the adder 2623 and the adder 2624. The output of the three-input adder 263 is coupled to the adder 2626.

In sum, the output of the three-input adder in FIG. 8 is the final result of multiplication, while in the implementations shown in FIG. 9 or FIG. 10, it is only part of the calculation process.

In view of the above, the present disclosure proposed a multiplier with in-path subnormal handling. For the multiplication of normal and subnormal floating numbers, the proposed multiplier not only efficiently determines the sticky bit for rounding, but also hides the latency associated with the reductive OR needed to identify a subnormal input.

What is claimed is:

1. A multiplier with in-path subnormal handling comprising:
a zero counter configured to receive a first mantissa and a second mantissa, and output a zero count by adding up a first trailing-zero count, a second trailing-zero count, and at least one of a first leading-zero count and a second leading-zero count;
a multiplication circuit configured to receive the first mantissa and the second mantissa, and output a mantissa product by multiplying the first mantissa and the second mantissa;
a comparator coupled to the zero counter and the multiplication circuit for receiving the zero count and a most significant bit of the mantissa product, wherein the comparator outputs a sticky bit by comparing the zero count and a sticky portion width varying according to the most significant bit of the mantissa product; and
a rounder coupled to the multiplication circuit and the comparator for receiving the mantissa product and the sticky bit, wherein the rounder outputs a mantissa result by performing a rounding operation according to the mantissa product and the sticky bit.

2. The multiplier with in-path subnormal handling of claim 1, wherein the zero counter comprises:
a first subnormal detector configured to receive a first exponent and determine a first subnormal flag according to whether the first exponent is zero or not;
a second subnormal detector configured to receive a second exponent and determine a second subnormal flag according to whether the second exponent is zero or not;
a first leading-zero counter coupled to the first subnormal detector for receiving the first subnormal flag and configured to receive the first mantissa, wherein the first leading-zero counter outputs the first leading-zero count by counting a quantity of leading-zero(s) of the first mantissa when the first subnormal flag is true;
a second leading-zero counter coupled to the second subnormal detector for receiving the second subnormal flag and configured to receive the second mantissa, wherein the second leading-zero counter outputs the second leading-zero count by counting a quantity of leading-zero(s) of the second mantissa when the second subnormal flag is true;
a first trailing-zero counter configured to receive the first mantissa and output the first trailing-zero count by counting a quantity of trailing-zero(s) of the first mantissa;
a second trailing-zero counter configured to receive the second mantissa and output the second trailing-zero count by counting a quantity of trailing-zero(s) of the second mantissa; and
a zero-count adder coupled to the first leading-zero counter, the second leading-zero counter, the first trailing-zero counter, and the second trailing-zero counter for receiving the first leading-zero count, the second leading-zero count, the first trailing-zero count, and the second trailing-zero count, where the zero-count adder outputs the zero count by adding up the first leading-zero count, the second leading-zero count, the first trailing-zero count, and the second trailing-zero count.

3. The multiplier with in-path subnormal handling of claim 1, wherein the zero counter comprises:
a first subnormal detector configured to receive a first exponent and determine a first subnormal flag according to whether the first exponent is zero or not;
a second subnormal detector configured to receive a second exponent and determine a second subnormal flag according to whether the second exponent is zero or not;
a first leading-zero counter coupled to the first subnormal detector for receiving the first subnormal flag and configured to receive the first mantissa, wherein the first leading-zero counter outputs the first leading-zero count by counting a quantity of leading-zero(s) of the first mantissa when the first subnormal flag is true;
a second leading-zero counter coupled to the second subnormal detector for receiving the second subnormal flag and configured to receive the second mantissa, wherein the second leading-zero counter outputs the second leading-zero count by counting a quantity of leading-zero(s) of the second mantissa when the second subnormal flag is true;
a first trailing-zero counter configured to receive the first mantissa and output the first trailing-zero count by counting a quantity of trailing-zero(s) of the first mantissa;
a second trailing-zero counter configured to receive the second mantissa and output the second trailing-zero count by counting a quantity of trailing-zero(s) of the second mantissa; and
a selector coupled to the first subnormal detector, the second subnormal detector, the first leading-zero counter, and the second leading-zero counter for receiving the first subnormal flag, the second subnormal flag, the first leading-zero count, and the second leading-zero count, wherein the selector outputs a selection result by selecting one of the first leading-zero count, the second leading-zero count, and zero according to the first subnormal flag and the second subnormal flag; and
a zero-count adder coupled to the selector, the first trailing-zero counter, and the second trailing-zero counter for receiving the selection result, the first trailing-zero count, and the second trailing-zero count, wherein the zero-count adder outputs the zero count by adding up the selection result, the first trailing-zero count, and the second trailing-zero count.

4. The multiplier with in-path subnormal handling of claim 1 further comprising:
an exponent adder configured to receive a first exponent and a second exponent and output an adjusted exponent by at least adding up the first exponent and the second exponent; and
the zero counter comprising:
a first subnormal detector configured to receive a first exponent and determine a first subnormal flag according to whether the first exponent is zero or not;
a second subnormal detector configured to receive a second exponent and determine a second subnormal flag according to whether the second exponent is zero or not;
a first leading-zero counter coupled to the first subnormal detector for receiving the first subnormal flag and configured to receive the first mantissa, wherein the first leading-zero counter outputs the first leading-zero count by counting a quantity of leading-zero(s) of the first mantissa when the first subnormal flag is true;
a second leading-zero counter coupled to the second subnormal detector for receiving the second subnormal flag and configured to receive the second mantissa, wherein the second leading-zero counter outputs the second leading-zero count by counting a quantity of leading-zero(s) of the second mantissa when the second subnormal flag is true;
a first trailing-zero counter configured to receive the first mantissa and output the first trailing-zero count by counting a quantity of trailing-zero(s) of the first mantissa;
a second trailing-zero counter configured to receive the second mantissa and output the second trailing-zero count by counting a quantity of trailing-zero(s) of the second mantissa; and
a first selector coupled to the first subnormal detector, the second subnormal detector, the first leading-zero counter, and the second leading-zero counter for receiving the first subnormal flag, the second subnormal flag, the first leading-zero count, and the second leading-zero count, wherein the first selector outputs a first selection result by selecting one of the first leading-zero count, the second leading-zero count, and zero according to the first subnormal flag and the second subnormal flag;
a second selector coupled to the exponent adder and the first selector for receiving the adjusted exponent and the first selection result, wherein the second selector outputs a second selection result by selecting a smaller one of the adjusted exponent and the first selection result; and
a zero-count adder coupled to the second selector, the first trailing-zero counter, and the second trailing-zero counter for receiving the second selection result, the first trailing-zero count, and the second trailing-zero count, wherein the zero-count adder outputs the zero-count by adding up the second selection result, the first trailing-zero count, and the second trailing-zero count.

5. The multiplier with in-path subnormal handling of claim 1, where the multiplication circuit comprises:
an increment generator configured to receive the first mantissa and the second mantissa, output a first mantissa increment by adding 1 to the first mantissa, and output a second mantissa increment by adding 1 to the second mantissa;
a customized multiplier coupled to the increment generator for receiving and multiplying the first mantissa increment and the second mantissa increment to output two partial products, wherein a sum of the two partial products is equal to a product of the first mantissa increment and the second mantissa increment;
an increment selector coupled to the increment generator for receiving the first mantissa increment and the second mantissa increment and configured to receive a first subnormal flag and a second subnormal flag, wherein the increment selector outputs a selection result by selecting one of the first mantissa increment, the second mantissa increment, and zero;
a subtractive-factor generator coupled to the increment selector for receiving the selection result, wherein the subtractive-factor generator outputs a two's complement of the selection result as a subtractive factor; and
a three-input adder coupled to the customized multiplier and the subtractive-factor generator for receiving the two partial products and the subtractive factor, wherein the three-input adder outputs the mantissa product by adding up the two partial products and the subtractive factor.

6. The multiplier with in-path subnormal handling of claim 1, where the multiplication circuit comprises:
a customized multiplier configured to receive and multiply the first mantissa and the second mantissa to output two partial products, wherein a sum of the two partial products is equal to a product of the first mantissa and the second mantissa;
a mantissa adder configured to receive the first mantissa and the second mantissa and output a sum increment by adding up the first mantissa, the second mantissa, and 1;
an additive-factor selector coupled to the mantissa adder for receiving the sum increment, and configured to receive the first mantissa, the second mantissa, a first subnormal flag, and a second subnormal flag, wherein the additive-factor selector outputs an additive factor by selecting one of the sum increment, the first mantissa, and the second mantissa according to the first subnormal flag and the second subnormal flag; and
a three-input adder coupled to the customized multiplier and the additive-factor selector for receiving the two partial products and the additive factor, wherein the three-input adder outputs the mantissa product by adding up the two partial products and the additive factor.

7. The multiplier with in-path subnormal handling of claim 1, where the multiplication circuit comprises:
a customized multiplier configured to receive and multiply the first mantissa and the second mantissa to output two partial products, wherein a sum of the two partial products is equal to the product of the first mantissa and the second mantissa;
a mantissa adder configured to receive and add the first mantissa and the second mantissa to output a mantissa sum;
an additive-factor selector coupled to the mantissa adder for receiving the mantissa sum, and configured to receive the first mantissa, the second mantissa, a first subnormal flag, and a second subnormal flag, wherein the additive-factor selector outputs an additive factor by selecting one of the mantissa sum, the first mantissa, and the second mantissa according to the first subnormal flag and the second subnormal flag;
a NOR logic circuit configured to receive the first subnormal flag and the second subnormal flag and output a NOR result by performing a NOR operation on the first subnormal flag and the second subnormal flag;
a three-input adder coupled to the customized multiplier and the additive-factor selector for receiving the two partial products and the additive factor, wherein the three-input adder outputs a temporary sum by adding up the two partial products and the additive factor;
a two-bit adder coupled to the NOR logic and the three-input adder for receiving the NOR result and an integer portion of the of the temporary sum, wherein the two-bit adder outputs a two-bit result by adding up the NOR result and the integer portion; and
a concatenation circuit coupled to the three-input adder and the two-bit adder for receiving a fractional portion of the temporary sum and the two-bit result, wherein the concatenation circuit outputs the mantissa product by concatenating the two-bit result and the fractional portion.

8. The multiplier with in-path subnormal handling of claim 1, where the multiplication circuit comprises:
a partial product generator configured to receive the first mantissa and the second mantissa and generate a plurality of partial products according to the first mantissa and the second mantissa;
an adder tree circuit coupled to the partial product generator for receiving the plurality of partial products and configured to add up the plurality of partial products to generate two intermediates; and
a three-input adder coupled to adder tree circuit for receiving the two intermediates and configured to receive a selection result, wherein the three-input adder outputs the mantissa result by adding up the two intermediates and the selection result.

9. The multiplier with in-path subnormal handling of claim 1, where the multiplication circuit comprises:
a partial product generator configured to receive the first mantissa and the second mantissa and generate a plurality of partial products according to the first mantissa and the second mantissa;
a three-input adder coupled to the partial product generator for receiving two of the plurality of partial products and configured to receive a selection result, wherein the three-input adder outputs an intermediate by adding up the two of the plurality of partial products and the selection result; and
an adder tree circuit coupled to the partial product generator and the three-input adder for receiving the plurality of partial products and the intermediate, wherein the adder tree circuit comprises a plurality of adders configured to add up the plurality of partial products and the intermediate to output the mantissa product.

10. The multiplier with in-path subnormal handling of claim 1, where the multiplication circuit comprises:
a partial product generator configured to receive the first mantissa and the second mantissa and generate a plurality of partial products according to the first mantissa and the second mantissa;
an adder tree circuit coupled to the partial product generator for receiving the plurality of partial products, wherein the adder tree circuit comprises a plurality of adders outputting two intermediates and the mantissa product by adding up the plurality of partial products; and
a three-input adder coupled to the adder tree circuit for receiving the two intermediates and configured to receive a selection result, wherein the three-input adder outputs a first temporary result by adding up the two intermediates and the selection result, and the first temporary result is an input of one of the plurality of adders of the adder tree circuit.
